(19) United States
(12) Patent Application Publication
(10) Pub. No.: US 2012/0062707 A1
(43) Pub. Date: Mar. 15, 2012

(54) METHOD AND APPARATUS FOR DETERMINING A CONVERGENCE ANGLE OF A STEREO CAMERA

(75) Inventors: Ja-Won Seo, Suwon-si (KR); Hae-Sun Lee, Seoul (KR); Jong-Hyub Lee, Chilgok-gun (KR); Sung-Jun Yim, Seoul (KR)

(73) Assignee: Samsung Electronics Co., Ltd., Suwon-si (KR)

(21) Appl. No.: 13/232,490

(22) Filed: Sep. 14, 2011

(30) Foreign Application Priority Data
Sep. 14, 2010 (KR) 10-2010-0090144

(51) Int. Cl. H04N 13/02

(52) U.S. Cl. 348/47; 348/E13.074

(57) ABSTRACT

An apparatus and method of determining a convergence angle of a stereo camera. The method includes setting interest regions by first and second cameras, respectively, the interest regions having a same size and being symmetric to each other; photographing images by the first and second cameras while varying a convergence angle of the stereo camera by a predetermined degree for each photographed image of the first and second cameras, respectively; analyzing image histograms of the interest regions for each of the first and second cameras; and setting an optimum convergence angle.

### PRIORITY

This application claims priority under 35 U.S.C. §119(a) to an application filed in the Korean Industrial Property Office on Sep. 14, 2010 and assigned Serial No. 10-2010-0090144, the content of which is hereby incorporated by reference.

### BACKGROUND OF THE INVENTION

1. Field of the Invention

The present invention relates generally to a stereo camera for acquisition of a three-dimensional (3D) image, and more particularly, to a method and an apparatus for determining a convergence angle of a subject photographed by the stereo camera.

2. Description of the Related Art

A stereoscopic 3D image refers to an image capable of expressing a 3D effect of an object, in addition to depth and space formation information, which cannot be achieved through a 2D image. Basically, a 3D effect is obtained by a difference between right and left images as seen by both eyes, and a stereoscopic 3D image is recognized through a synthesizing process by the brain. In order to photograph a stereoscopic 3D image, a stereo camera including two cameras that are operated in conjunction with each other is used.

Generally, a stereo camera refers to an apparatus for generating a stereoscopic image, and the stereoscopic image is generated using a difference between view angles of both eyes, i.e., the right and left eyes. More specifically, the two eyes of a human being are spaced apart from each other by a distance, and a binocular disparity is generated because an image based on a view angle of the right eye differs from an image based on a view angle of the left eye. Thus, two cameras, i.e., right and left cameras, which are spaced apart from each other by a distance similar to that of human eyes, are used to generate an image showing a 3D effect similar to one generated by eyes. Accordingly, a stereo camera includes at least a right camera and a left camera, and a stereoscopic image is generated by using the right and left cameras photographing a subject at different positions, which is similar to a stereoscopic image generated due to a binocular disparity of human eyes.

FIG. 1 illustrates a conventional stereo camera.

Referring to FIG. 1, the stereo camera includes a system controller 40 having a microcomputer that controls the entire camera, and a release switch 13a, operation switches 14a and 15a, and a function dial switch 12a which are switched on and off are connected to the system controller 40.

Further, a distance measuring unit 16 measures a distance from a subject, a convergence angle adjusting mechanism 45 adjusts a convergence angle, a first lens driving circuit 41 drives an Auto Focus (AF) lens of a right photographing optical system RL, a second lens driving circuit 42 drives an AF lens of a left photographing optical system LL, a first Charge Coupled Device (CCD) driving circuit 43 drives a right CCD 23, and a second CCD driving circuit 44 drives a left CCD 24. Also, a first Liquid Crystal Display (LCD) driving circuit 46 drives a right LCD 17R and a second LCD driving circuit 47 drives a left LCD 17L. Additionally, a first Correlated Double Sampling/Automatic Gain Control (CDS/AGC) circuit 48 is connected to the right CCD 23, and a second CDS/AGC circuit 49 is connected to the left CCD 24.

The stereo camera also includes a first Analog-to-Digital (A/D) converter 50, a second A/D converter 52, a signal processor 53, and a memory controller 54. Further, an image storage 55 stores image data in a memory medium, e.g., a flash memory.

In the stereo camera, an image signal acquired by the right CCD 23 is A/D-converted by the first A/D converter 50 via the first CDS/AGC circuit 48 and is stored in the memory 52. Likewise, an image signal acquired by the left CCD 24 is A/D-converted by the second A/D converter 51 via the second CDS/AGC circuit 49 and is also stored in the memory 52. The image signals stored in the memory 52 are processed by the signal processor 53, and are output through the right LCD 17R and the left LCD 17L, respectively.

The conventional stereo camera measures a distance from a subject using a distance measuring unit 16 and adjusts convergence angles of both cameras through the convergence angle adjusting mechanism 45, based on the measured distance. However, because the distance measuring unit 16 is an additional physical component, the size and volume of the conventional stereo camera are large and its manufacturing expense is high.

### SUMMARY OF THE INVENTION

Accordingly, the present invention has been made to solve at least the above-described problems occurring in the prior art, and an aspect of the present invention is to provide a method and apparatus for measuring a distance from a stereo camera to a subject and a convergence angle.

In accordance with an aspect of the present invention, a method is provided for determining an optimum convergence angle of a stereo camera including a first camera and a second camera. The method includes setting interest regions in images to be photographed by the first camera and the second camera, respectively, the interest regions having a same size and being symmetric to each other with respect to a central vertical axis of the images to be photographed; photographing images by the first camera and the second camera while varying a convergence angle of the stereo camera by a predetermined degree for each photographed image of the first camera and the second camera, respectively; analyzing image histograms of the interest regions for each of the images photographed by the first camera and the second camera; and setting a convergence angle, at which differences between image histograms of the interest regions of an image photographed by a the first camera and image histograms of the interest regions of the image photographed by the second camera are smallest, as an optimum convergence angle.

In accordance with another aspect of the present invention, an apparatus for determining a convergence angle of a stereo camera is provided. The apparatus includes a first camera; a second camera; a first drive for driving the first camera; a second drive for driving the second camera; a memory; and a controller. The controller sets interest regions in images to be photographed by the first camera and the second camera, respectively, the interest regions having a same size and being symmetric to each other with respect to a central vertical axis of the images to be photographed; controls the first camera and the second camera to photograph images while varying a convergence angle of the stereo camera by a predetermined degree for each photographed image of the first camera and the second camera, respectively; analyzes image histograms of the interest regions for each of the images photographed by the first camera and the second camera; and sets a convergence angle, at which differences between image histograms of the interest regions of an image photographed by a the first camera and image histograms of the interest regions of the image photographed by the second camera are smallest, as an optimum convergence angle.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a conventional stereo camera;

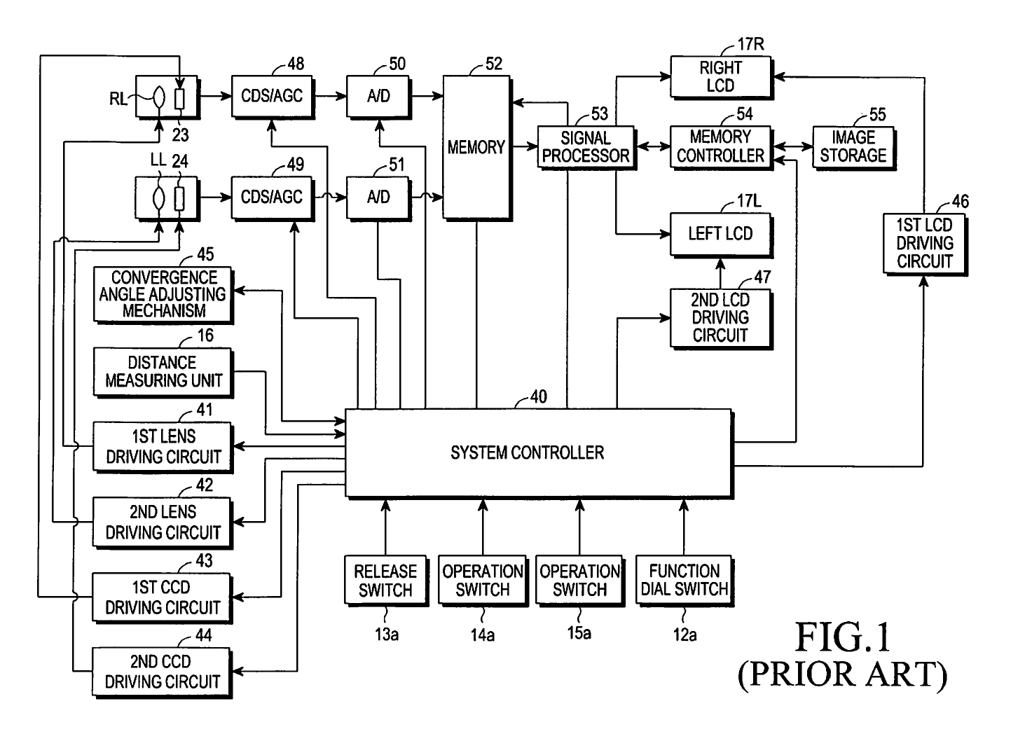

FIG. 2 is a block diagram illustrating a convergence angle determining apparatus of a stereo camera according to an embodiment of the present invention;

FIGS. 3A to 3C illustrate images of a subject photographed by image sensors according to convergence angles of a stereo camera, according to an embodiment of the present invention;

FIGS. 4A to 4C illustrate statistics data of interest regions of image sensors according to convergence angles of a camera, according to an embodiment of the present invention;

FIG. 5 is a flowchart illustrating a convergence angle determining operation of a stereo camera, according to an embodiment of the present invention; and

FIG. 6 is a graph illustrating an example of a PieceWise Linear (PWL) function during a convergence angle determination by a stereo camera, according to an embodiment of the present invention.

### DETAILED DESCRIPTION OF EMBODIMENTS OF THE INVENTION

Hereinafter, various embodiments of the present invention will be described with reference to the accompanying drawings. In the following description, same elements will be designated by same reference numerals although they are shown in different drawings. Further, various specific definitions found in the following description are provided only to help general understanding of the present invention, and it is apparent to those skilled in the art that the present invention can be implemented without such definitions. Further, in the following description of the present invention, a detailed description of known functions and configurations incorporated herein will be omitted to avoid obscuring the subject matter of the present invention.

In accordance with an embodiment of the present invention, a method is provided for determining a convergence angle of a stereo camera. For this purpose, the method may include setting interest regions in each image photographed by the stereo camera. The interest regions have a same size and are symmetric to each other with respect to a central vertical axis of the photographed image. A photographing operation is performed through the stereo camera while varying a convergence angle of the stereo camera and a convergence scanning operation is then performed by analyzing image histograms of the interest regions of each image photographed at a corresponding angle. A photographing angle, at which differences between image histograms of the interest regions of the image photographed by a left camera of the stereo camera and image histograms of the interest regions of the image photographed by a right camera of the stereo camera are minimal, is then determined as the optimum convergence angle.

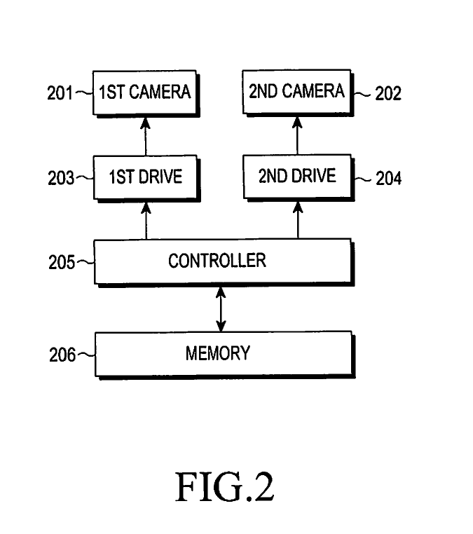

FIG. 2 is a block diagram illustrating a convergence angle determining apparatus of a stereo camera according to an embodiment of the present invention.

Referring to FIG. 2, the convergence angle determining apparatus includes a first camera 201 and a second camera 202, which are located respectively on left and right sides to photograph a subject, a first drive 203 for driving the first camera 201 and a second drive 204 for driving the second camera 202, a memory 206 for storing information for operating the stereo camera, and a controller 205 for controlling the elements of the stereo camera.

When determining a convergence angle, the controller 205 sets two pairs of interest regions. The interest regions have a same size and are symmetric to each other with respect to central vertical axes of images photographed by the first camera 201 and the second camera 202 on opposite sides. The controller 205 then controls the cameras 201 and 202 to perform photographing operations with a convergence angle of the stereo camera being varied and performs a convergence scanning operation by analyzing image histograms of the interest regions of the images photographed at a corresponding angle. The controller 205 also determines a convergence angle that minimizes a difference between image histograms of the interest regions of the image photographed by the left camera 201 and image histograms of the interest regions of the image photographed by the right camera 202, as an optimum convergence angle.

For example, the interest regions may be set to have one or more rectangular regions, which are symmetric to each other with respect to central vertical axes of the photographed images on opposite sides.

During the convergence scanning operation, while varying a convergence angle of the stereo camera, the controller 205 calculates a difference between image histograms of the interest regions of the image photographed by the left camera 201 and image histograms of the interest regions of the image photographed by the right camera 202 for the varied convergence angles, respectively, and stores a minimum value of the differences of the image histograms in the memory 206.

If a difference between image histograms of the interest regions of the image photographed by the left camera 201 and image histograms of the interest regions of the image photographed by the right camera 202 for a convergence angle is greater than a predetermined multiple (n) of a minimum value of the differences of the stored image histograms, the convergence scanning operation is completed.

The controller 205 performs calculates a distance between the stereo camera and a subject, and determines a binocular disparity of a central subject based on the calculated distance between the stereo camera and the subject. Specifically, the controller 205 calculates a crossed disparity, an uncrossed disparity, a maximum crossed disparity, and a maximum uncrossed disparity using both a view distance of a display input by a user and size information of the display.

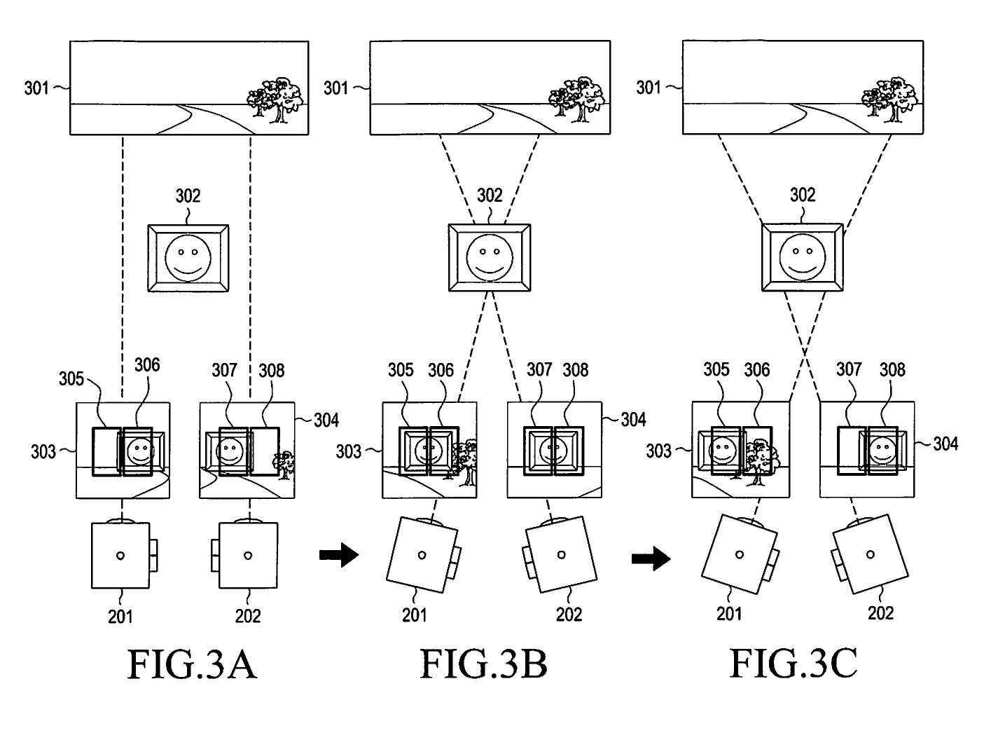

FIGS. 3A to 3C illustrate images of a subject photographed by image sensors based on convergence angles of a stereo camera according to the embodiment of the present invention. Specifically, FIGS. 3A to 3C illustrate images 303 and 304, where a subject 302 and a background 301 are photographed based on convergence angles of first camera 201 and second camera 202 of the stereo camera.

Referring to FIGS. 3A to 3C, interest regions W1 (305 and 307) and W2 (306 and 308) are set on left and right sides of central vertical axes of the photographed images. The interest regions on left and right sides are symmetric to each other. For example, one or more regions may be set respectively on left and right sides in a rectangular form. The interest regions are set in a region where a subject is expected to be located when the subject is photographed at a suitable convergence angle.

Referring to FIG. 3A, if a convergence angle of the stereo camera is set such that both the first camera 201 and the second camera 202 face the front side, i.e., when a convergence angle of the stereo camera is zero, the subject 302 is located on the right side of an image 303 photographed by the first camera 201 and is located on the left side of an image 304 photographed by the second camera 202.

Referring to FIG. 3B, if a convergence angle of the first camera 201 and the second camera 202 is set to for photographing a central subject, the subject 302 is located around central portions of the images 303 and 304 photographed through the first camera 201 and the second camera 202, providing similar images to be displayed in the interest regions of the two photographs 303 and 304.

Referring to FIG. 3C, a convergence angle of the first camera 201 and the second camera 202 is set too large as compared with a position of a central subject. Accordingly, the subject 302 is located on the left side of the image 303 photographed through the first camera 201 and is located on the right side of the image 304 photographed through the second camera 202.

When a convergence angle of the stereo camera is too small or large as illustrated in FIGS. 3A and 3C, such that the convergence angle is not suitable for photographing subject 302, different images are displayed in the interest regions 305, 306, 307, and 308 of the two photographed images 303 and 304. However, when a convergence angle of the stereo camera is appropriately set as illustrated in FIG. 3B, in the two photographed images 303 and 304, the images displayed in the interest regions 305 and 307 are similar to each other, and the images displayed in the interest regions 306 and 308 are similar to each other.

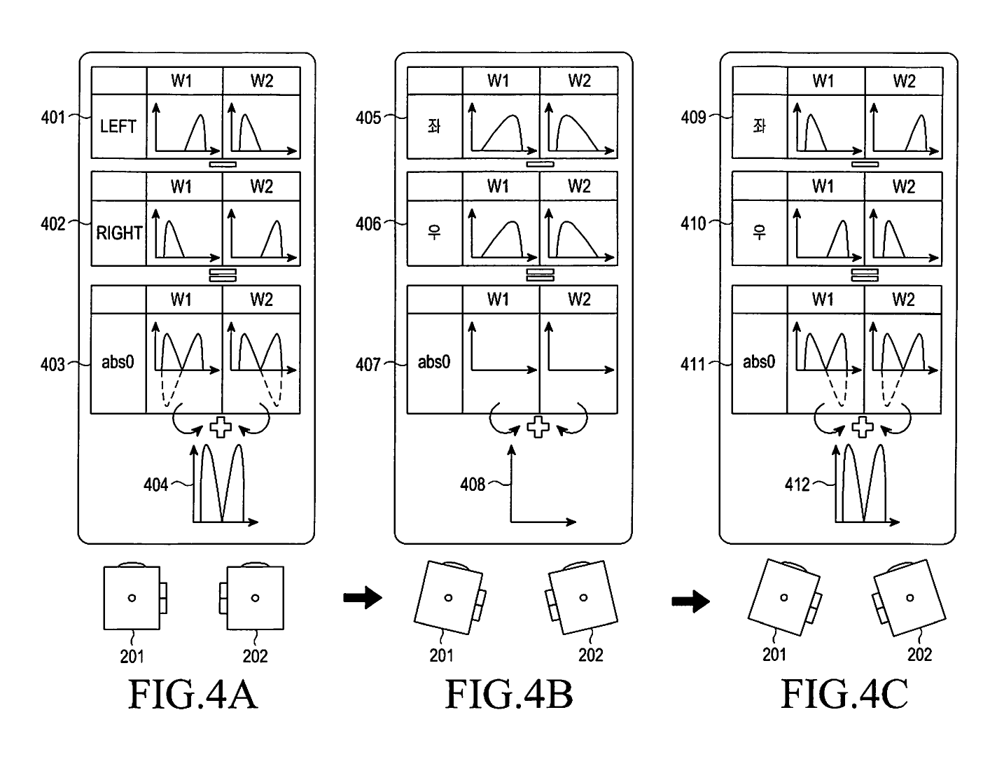

FIGS. 4A to 4C illustrate statistics data of interest regions of image sensors according to convergence angles of a camera, according to the embodiment of the present invention. Specifically, FIGS. 4A to 4C illustrate results obtained by analyzing image histograms of the interest regions of the photographed images according to various situations, as illustrated in FIGS. 3A to 3C.

Image histograms are tools used to show information regarding contrast values of images, and configurations of images, i.e., contrasts and distribution of contrast values can be recognized using histograms. Generally, an image histogram expresses contrast values in a bar graph. Contrast values of pixels are expressed on the x-axis and frequencies of the contrast values are expressed on the y-axis.

A convergence angle of the stereo camera is set to be suitable for a distance of a central subject, such that the images displayed in the interest regions of first camera 201 and second camera 202 are similar to each other, making the image histograms of the interest regions similar. Accordingly, in accordance with an embodiment of the present invention, an angle at which differences between image histograms of the interest regions of the image photographed by the first camera and image histograms of the interest regions of the image photographed by the second camera is minimal, is determined as an optimum convergence angle for photographing the subject. Therefore, a convergence angle of a stereo camera may be expressed as shown in Equation (1).

$$Convergen Angle = {argmin}_{δ} ( \vert {W}_{1 , L} - {W}_{1 , R} \vert + \vert {W}_{2 , L} - {W}_{2 , R} \vert ) \qquad ( 1 )$$

In Equation (1), W represents an image histogram in an interest region. For example, W_{1,L} represents an image histogram of the interest region 305 on the left side of an image photographed by the first camera 201, W_{1,R} represents an image histogram of the interest region 307 on the left side of the image photographed by the second camera 202, W_{2,L} represents an image histogram of the interest region 306 on the right side of an image photographed by the first camera 201, and W_{2,R} represents an image histogram of the interest region 308 on the right side of the image photographed by the second camera 202

Referring to FIG. 4A, these histograms correspond to a situation in which a convergence angle of both the cameras is zero, i.e., FIG. 3A. In this case, the images displayed in the interest regions of the photographed images of the first and second cameras 201 and 202, i.e., the left and right cameras, are different. Accordingly, there are differences between the histograms 401 of the interest regions of the photographed image of the first camera 201 and the histograms 402 of the interest regions of the photographed image of the second camera 202. In this case, a difference (W1 of 403) between the left interest regions 305 and 307 of the photographed images of the first and second cameras 201 and 202 and a difference (W2 of 403) between the right interest regions 306 and 308 of the photographed images of the first and second cameras 201 and 202 are obtained, respectively, and a relatively large result value 404 is obtained by adding the absolute values of the differences.

FIG. 4B illustrates a situation in which a convergence angle of both the cameras is suitable for photographing a subject, i.e., FIG. 3B. In this case, the images displayed in the interest regions of the photographed images of the first and second cameras 201 and 202, i.e., the left camera and the right camera, are similar, and accordingly the histograms 405 of the interest regions of the photographed image of the first camera 201 and the histograms 406 of the interest regions of the photographed image of the second camera 201 are similar. Accordingly, because a difference (W1 of 407) between the histograms of the left interest regions 305 and 307 of the photographed images of the first camera 201 and the second camera 202 and a difference (W2 of 407) between the histograms of the right interest regions 306 and 308 of the photographed images of the first camera 201 and the second camera 202 are very small, a very small value 408 is obtained by adding the absolute values of the differences, thereby making it possible to obtain zero in an ideal case.

FIG. 4C illustrates a situation in which a convergence angle of both the cameras is very large, relative to a distance between the stereo camera and the subject, i.e., FIG. 3C. In this case, the images displayed in the interest regions of the photographed images of the first and second cameras 201 and 201, i.e., the left camera and the right camera, are different. Accordingly there are differences between the histograms 409 of the interest regions of the photographed image of the first camera 201 and the histograms 410 of the interest regions of the photographed image of the second camera 202. After obtaining a difference (W1 of 411) between the histograms of the left interest regions 305 and 307 of the photographed images of the first camera 201 and the second camera 202 and obtaining a difference (W2 of 411) between the histograms of the right interest regions 306 and 308 of the photographed images of the first camera 201 and the second camera 202, a relatively large value 412 is obtained by adding the absolute values of the differences.

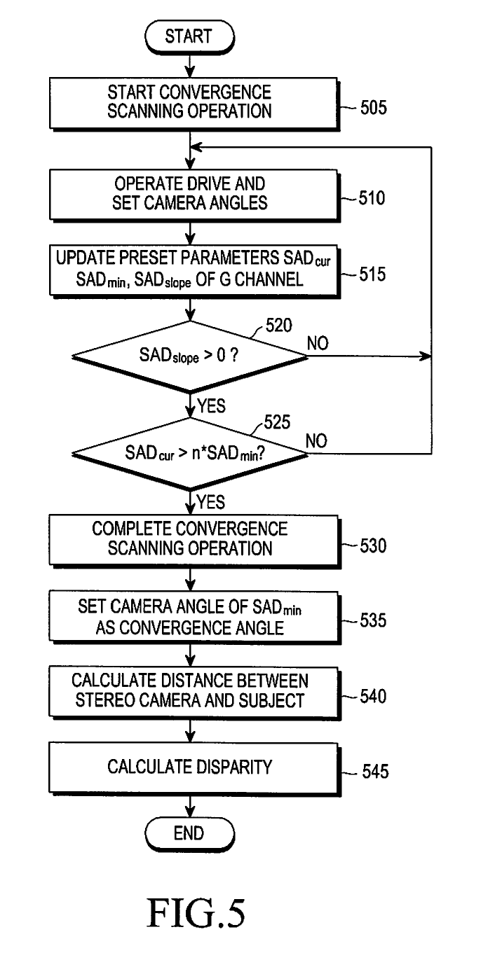

FIG. 5 is a flowchart illustrating a convergence angle determining operation of a stereo camera according to an embodiment of the present invention.

Referring to FIG. 5, convergence angle scanning is started in step 505, and a camera angle is set by operating the drives 203 and 204 in step 510. In accordance with an embodiment of the present invention, a convergence scanning operation is performed while increasing the convergence angle in units of a predetermined angle, starting from zero. Thereafter, interest regions having a same size and being symmetric to each other with respect to central vertical axes of the images photographed through the stereo camera are set.

In step 515, three Sum of Absolute Difference (SAD) variables, i.e., SAD_{cur}, SADₘᵢₙ, and SADₛₗₒₚₑ, are updated. SAD indicates a sum of absolute values of a value obtained by subtracting a pixel of a previous reference frame from a pixel of a current frame with respect to a specific area of an image.

SAD_{cur} is a value of |W_{1,L}−W_{1,R}|+|W_{2,L}−W_{2,R}| which is calculated at a current camera angle, SADₘᵢₙ is a smallest value of SAD_{cur} values calculated at different angles, i.e., Min(SAD_{cur}, SADₘᵢₙ), and SADₛₗₒₚₑ represents a difference between a current SAD_{cur} value and a SAD_{cur} value calculated at a previous angle, i.e., SAD_{cur}-SAD_{cur-1}. In accordance with an embodiment of the present invention, when image histograms are obtained, Green (G) channels of RGB channels of images are used to obtain the image channels.

Generally, when a convergence scanning operation is performed, e.g., starting from a convergence angle of zero, SAD_{cur} per angle has a form of a parabola having a minimum value similar to a quadratic function. Thus, when SAD_{cur} has a positive value, this indicates that a convergence angle of the current camera exceeds an optimal convergence angle. Accordingly, when it is determined that the SADₛₗₒₚₑ value is larger than zero in step 520, and that SAD_{cur} is larger than n times SADₘᵢₙ in step 525, the convergence scanning operation is completed in step 530. That is, if SAD_{cur} increases from SADₘᵢₙ by more than a predetermined ratio, the convergence scanning operation is completed in step 530, and an angle corresponding to SADₘᵢₙ is determined as an optimum convergence angle in step 535. The n is a threshold value for determining whether a convergence scanning operation is to be stopped if SAD_{cur} is larger than SADₘᵢₙ by a predetermined times.

However, when it is determined that either the SADₛₗₒₚₑ value is not larger than zero in step 520, or that SAD_{cur} is not larger than n times SADₘᵢₙ in step 525, the operation returns to step 510.

After the optimum convergence angle is set, in step 540, a distance between the stereo camera and the subject is calculated. For example, the distance between the stereo camera and the subject may be calculated as shown in Equation (2).

Do=ICD/(2*tan ∇) (2)

In Equation (2), Do is a distance between the stereo camera and the subject, Inter Camera Distance (ICD) is a distance between the cameras, and ∇ represents the convergence angle set in step 535.

In step 545, a binocular disparity of a subject which is to be applied to an actual display is determined based on the distance information of the subject, in which method an approximate view distance of the display and a size of the display are input through a User Interface (UI) during a stereo photographing operation, and a max crossed disparity and a max uncrossed disparity where a user begins to feel fatigue while watching a stereo image in a corresponding display view environment are calculated.

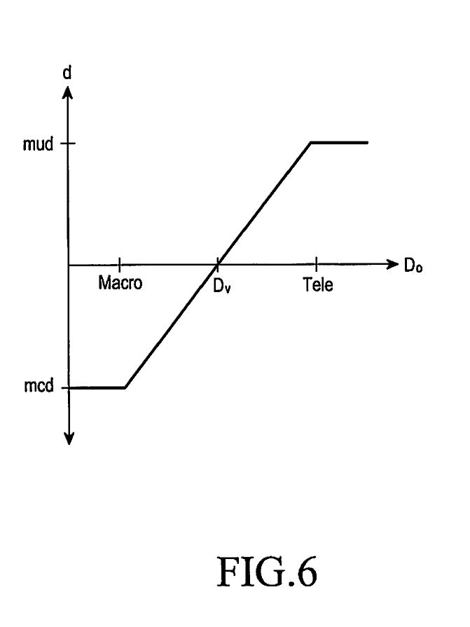

FIG. 6 is a graph illustrating an example of a PWL function during determination of a disparity, according to an embodiment of the present invention. Specifically, when a max crossed disparity and a max uncrossed disparity are determined, a PWL function is applied so that a user can arbitrarily determine a disparity corresponding to a distance of the subject.

Referring to FIG. 6, Do represents a distance between the stereo camera and a subject, Dv represents a view distance of the display input by a user, d represents a disparity in unit of a distance, Macro represents a close-up distance, and Tele represents a telescope distance. Further, Mud represents a Max uncrossed disparity, and MCD represents Max Crossed Disparity.

The disparity calculated in units of distances are converted into units of pixels of the display, and the result is transferred in a stereo matching step. Through such an operation, a convergence angle determining process of the stereo camera is completed, and the cameras perform an automatic focusing operation.

As described in the embodiments of the present invention above, a distance between a stereo camera and a central subject can be measured without using a separate mechanical distance measuring apparatus to determine a convergence angle of the stereo camera. Accordingly, costs for manufacturing a stereo camera system are reduced. Further, fatigue of a user can be alleviated while the user is watching a stereo image by suggesting a disparity adjusting value for stereo matching using a distance between the stereo camera and a subject.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method of determining a convergence angle by a stereo camera including a first camera and a second camera, the method comprising:
setting interest regions in images to be photographed by the first camera and the second camera, respectively, the interest regions having a same size and being symmetric to each other with respect to a central vertical axis of the images to be photographed;
photographing images by the first camera and the second camera while varying a convergence angle of the stereo camera by a predetermined degree for each photographed image of the first camera and the second camera, respectively;
analyzing image histograms of the interest regions for each of the images photographed by the first camera and the second camera; and
setting a convergence angle, at which differences between image histograms of the interest regions of an image photographed by a the first camera and image histograms of the interest regions of the image photographed by the second camera are smallest, as an optimum convergence angle.

2. The method of claim 1, wherein the interest regions include a rectangular region in each interest region.

3. The method of claim 1, wherein analyzing the image histograms of the interest regions for each of the images photographed by the first camera and the second camera comprises:
calculating the differences between the image histograms of the interest regions of the images photographed by the first camera and the image histograms of the interest regions of the images photographed by the second camera;
adding absolute values of the differences of the image histograms for the images photographed at each convergence angle; and
storing a minimum value of the added absolute values of the differences.

4. The method of claim 3, further comprising completing the photographing and analyzing when an added absolute value of differences between image histograms of the interest regions of an image photographed by the first camera and image histograms of the interest regions of the image photographed by the second camera is greater than a predetermined multiple of the stored minimum value of the added absolute values.

5. The method of claim 1, further comprising calculating a distance between the stereo camera and a subject being photographed.

6. The method of claim 5, wherein the distance between the stereo camera and the subject is calculated using
Do=ICD/(2*tan ∇),
wherein Do represents the distance between the stereo camera and the subject, Inter-Camera Distance (ICD) represents a distance between the first camera and the second camera, and ∇ represents a determined convergence angle.

7. The method of claim 1, further comprising determining a binocular disparity of a subject being photographed, based on a calculated distance between the stereo camera and the subject.

8. The method of claim 7, wherein determining the binocular disparity of the subject based on the calculated distance between the stereo camera and the subject comprises calculating a maximum crossed disparity and a maximum uncrossed disparity based on information regarding a view distance of a display and a size of the display.

9. The method of claim 8, wherein the information regarding the view distance of the display is input by a user.

10. The method of claim 1, wherein the image histograms are generated using green channels of the photographed images.

11. An apparatus for determining a convergence angle of a stereo camera, the apparatus comprising:
a first camera;
a second camera;
a first drive for driving the first camera;
a second drive for driving the second camera;
a memory;
a controller for:
setting interest regions in images to be photographed by the first camera and the second camera, respectively, the interest regions having a same size and being symmetric to each other with respect to a central vertical axis of the images to be photographed;
controlling the first camera and the second camera to photograph images while varying a convergence angle of the stereo camera by a predetermined degree for each photographed image of the first camera and the second camera, respectively;
analyzing image histograms of the interest regions for each of the images photographed by the first camera and the second camera; and
setting a convergence angle, at which differences between image histograms of the interest regions of an image photographed by a the first camera and image histograms of the interest regions of the image photographed by the second camera are smallest, as an optimum convergence angle.

12. The apparatus of claim 11, wherein the interest regions comprise a rectangular region in each interest region.

13. The apparatus of claim 11, wherein when the controller analyzes the image histograms of the interest regions for each of the images photographed by the first camera and the second camera, by calculating the differences between the image histograms of the interest regions of the images photographed by the first camera and the image histograms of the interest regions of the images photographed by the second camera, adding absolute values of the differences of the image histograms for the images photographed at each convergence angle, and storing a minimum value of the added absolute values of the differences.

14. The apparatus of claim 13, wherein the controller completes the photographing and analyzing when an added absolute value of differences between image histograms of the interest regions of an image photographed by the first camera and image histograms of the interest regions of the image photographed by the second camera is greater than a predetermined multiple of the stored minimum value of the added absolute values.

15. The apparatus of claim 11, wherein the controller calculates a distance between the stereo camera and a subject being photographed.

16. The apparatus of claim 15, wherein the distance between the stereo camera and the subject is calculated using
Do=ICD/(2*tan ∇),
wherein Do represents the distance between the stereo camera and the subject, Inter-Camera Distance (ICD) represents a distance between the first camera and the second camera, and ∇ represents a determined convergence angle.

17. The apparatus of in claim 11, wherein the controller determines a binocular disparity of a subject to be photographed based on a calculated distance between the stereo camera and the subject.

18. The apparatus of claim 17, wherein when the controller determines the binocular disparity of the subject based on the calculated distance between the stereo camera and the subject, by calculating a maximum crossed disparity and a maximum uncrossed disparity using information regarding a view distance of a display and a size of the display.

19. The apparatus of claim 18, wherein the information regarding the view distance of the display is input by a user.

20. The apparatus of claim 11, wherein the image histograms are generated from green channels of the photographed images.
